(19) United States
(12) Patent Application Publication
(10) Pub. No.: US 2012/0132555 A1
(43) Pub. Date: May 31, 2012

(54) Method for lubrication of dental floss immediately before using thereof and package kits therefor

(76) Inventor: Zoya Lavrova, Brooklyn, NY (US)

(21) Appl. No.: 12/927,839

(22) Filed: Nov. 26, 2010

(51) Int. Cl. A61C 15/04; A61C 19/02

(52) U.S. Cl. 206/369; 132/321

(57) ABSTRACT

A kit for lubricating dental floss comprises a flat base coupled to a panel defining a plurality of channels each containing a floss piece formed as an elongated loop having a bend and two free ends, lubrication zones, and compartments filled with lubricant, essentially formed of a flexible membrane, facing the respective lubrication zones. Each compartment includes dispenser orifices located near the bends, such that the vicinities of bends are lubricated upon a user's depressing on the membrane. An optional kit comprises a panel including cells each having dry and lubricant cavities, floss pieces each having a bend and two free ends, whereat the floss piece's middle portion is located in the lubricant cavity, the free ends are located in the dry cavity, and a flat cover coupled to the panel sealingly covering the cells. Preferred types of the floss and lubricant for the kits are also disclosed.

### FIELD OF THE INVENTION

The present invention relates to the oral care field, particularly to dental floss devices with improved properties.

### BACKGROUND OF THE INVENTION AND RELATED ART

Different methods for imparting medications (e.g. fluorides) or cleaning/bleaching agents into the dental floss (especially into the multi-stranded floss) have been widely known in the art. Some of them are listed herein below. For example, flosses may be coated by waxes, containing fluoride. Since, wax is impervious, the user needs a certain time to free the floss surface from the wax, and then a certain time for fluoride to reach the tooth surface, i.e. the time of flossing should be significantly extended, which would cause inconvenience for the user.

The use of antimicrobial agents for the supplemental or adjunctive treatment of gingival and periodontal infections may be systemic or local. ‘Local delivery’ means that the medication used to treat the periodontal infection is concentrated at the site of infection. Knowledge that periodontal diseases are site-specific infections has led to the development of methods for placing antimicrobials directly at the site of the infection, a so-called ‘pocket’. Studies have shown that a repopulation of subgingival microflora can occur within a week after the treatment by means of scaling and root planning. The instruments used during this mechanical procedure cannot always reach the bacteria that hide at the bottom of the pockets. On the other hand, the delivery of antimicrobial agents to the pockets may enhance the treatment effects. These antimicrobial agents can disrupt a number of microorganisms.

Employing a dental floss with antimicrobial agents provides a supplemental therapeutic step and results in additional clinical benefits. Using the dental floss with an antimicrobial agent before scaling and root planning can aid in reducing the number of microorganisms to prevent aerosol contamination during the instrumentation. Dental flosses that incorporate the antimicrobial agents can be very useful for: —patients with site (s) not responding to traditional periodontal care; —patients with gingivitis super imposed on periodontitis; —patients with areas inaccessible to mechanical instrumentation because of root contour, furcations, or depth of pocket where open scaling and root planning are not alternatives. Such dental flosses may—reduce the bacteria causing infection of gum; —shrink the size of periodontal pockets; and—manage the infection to stop it from spreading or becoming more severe.

Dental floss may also be impregnated with fluorides for prevention of tooth decay.

Whitening the dental floss with bleaching agents is designed for cosmetic reasons (whiter, brighter smile, fresh breath). It can be provided with the same concentration of whitening agents as bleaching agents. Other types of additive agents are also known, for instance: Xylitol, moistening agents, suppressing appetite agents, healing agents, antifungal agents etc. The dental floss impregnated with suppressive appetite compositions have intense flavor and suppress the appetite of the consumer after flossing their teeth. This provides a harmless topical means of controlling weight without ingesting drugs troches, lozenges. Such combinations of dental floss and suppressing appetite agents might promote weight loss while simultaneously promoting the intraoral cleanliness.

There is known U.S. Pat. No. 4,162,688 teaching: “A floss holder includes a bobbin of preferably unwaxed floss which feeds through a chamber containing a medication, such as fluoride. While in the chamber, the floss passes through a number of bearing surfaces for squeezing the medication into the floss without disturbing the lay of the fibers in the floss. After leaving the medication chamber, the floss passes out of the floss holder, over a stand-off prong and to a cutter. A clutch may be provided in the bobbin to maintain a floss tension throughout the medication chamber.”

Another U.S. Pat. No. 5,937,874 to Guay, et al describes: “A dental hygiene article that includes a dental floss, a first component associated with the floss, a second component associated with the floss, and a first barrier constructed to separate the first component from the second component until flossing occurs. The first and the second components are selected to react with each other when the first and the second components are combined, e.g., in the mouth during flossing.”

Another U.S. Pat. No. 5,819,767 describes “sterile dental floss segments having integral tips on the ends thereof, that are compatible for use in dental floss rings and similar type dental floss holders. The dental floss segments have a predetermined length, and are enclosed in a laminated web matrix containing multiple strands of dental floss, which maintains the integrity of the sterility of the dental floss, even after one or more of the strands are removed for use, and also allows for the sterilization of the dental floss strands after laminating the web. The present invention further relates to the method and apparatus to manufacture the sterile web units containing the sterilized dental floss segments with the integral tips on the ends. The method includes unwinding strands of floss in a parallel fashion, such that the strands resemble a web coming off a loom, passing the web through a thread guide to align and adjust the tension in the floss, applying beads of hot melt adhesive material to the exposed sections of the floss to create tips on the ends of the floss, laminating the floss with two layers of sterilizable glassine substrate material, perforating and die-cutting sections of the laminated web across the web at the back hardened beads.”

U.S. Pat. No. 7,578,039 to Finger et al describes “A method for making-up a wedge thread connection comprising a pin member and a box member includes applying a pipe dope to at least one of the pin member and the box member, wherein the pin member and the box member comprise corresponding wedge threads, reducing the viscosity of the pipe dope at least temporarily, and rotating the pin member relative to the box member to make-up the wedge thread connection, wherein the rotation occurs while the viscosity of the pipe dope is at least temporarily reduced. A collar to be used with a tong assembly in making-up a threaded connection between a pin member and a box member includes at least one power unit configured to temporarily reduce the viscosity of pipe dope applied to at least one of the pin member and the box member, and an inner surface having a selected diameter to correspond to an outer diameter of at least one of the pin member and the box member.”

U.S. Pat. No. 7,398,784 to Ochs et al mentions a coating of the whole length of floss, which coating is applied through a dip coating process, or a spray coating, or a dry electrostatic deposition.

U.S. Pat. No. 7,152,611 to Brown, et al discloses multifilament dental devices coated over with biofilm-responsive, imbedded particulate abrasives before putting on the spool. Saliva soluble particulate abrasive can be imbedded into liquid base coatings on multifilament dental flosses by various sparing means or for impinging particulate abrasives into liquid coated multifilament. Sound waves are used to suspend the particulate abrasives before introducing the fluidized particulate abrasive into a nozzle means.

U.S. Pat. No. 4,414,990 to Yost describes “A fluoridated dental article for cleaning the interproximal surfaces of the teeth, such as dental floss or dental tape, comprising filaments coated with a wax coating that is in turn coated with a polymeric coating containing a fluoride salt.”

U.S. Pat. No. 6,733,745 to Rozzi, et al describes “Devices, coating compositions and methods for making such compositions are provided, wherein the coatings deliver chlorhexidine gluconate from a stable non-aqueous system.”

U.S. Pat. No. 6,536,448 to Mc Devitt, et al teaches “ . . . a dental device that comprises a hemostatic agent and a method of making and using a dental device comprising a hemostatic agent.”

Yet, U.S. Pat. No. 6,029,678 to Tsao, et al discloses: “Monofilament gel dental flosses and methods for their fabrication are provided. The gel flosses comprise a core material in combination with a gel material, where both the core and gel materials comprise thermoplastic elastomeric polymers and are sufficiently adherent to one another so as not to separate under conditions of hygienic use.”

The aforementioned related art inventions have however certain shortcomings. For example, when a user uses the floss, whose entire length is covered by medication, this floss winds around the fingers that creates some inconvenience for usage thereof. When the medication includes a bleaching (e.g. caustic) agent, the user may smell it on the skin; such agent can also affect the user's skin on the fingers.

Covering the whole length of floss with medications (versus covering only the active/cleaning portion of the floss' length) requires an excessive amount of the medications, making the final product more expensive. Where the medication is protected by a coating layer produced by the manufacturer, the coating layer makes the floss thicker, i.e. inconvenient for many users.

Besides, the medication, that impregnates the floss at the manufacturing stage, may decompose or partially lose its healing properties at the moment of consuming the floss by the user.

### OBJECTS AND BRIEF GENERAL DESCRIPTION OF THE INVENTION

### Objects

The known methods for lubrication, impregnation, and utilization of dental flosses, as well as the problems associated therewith, are discussed hereinabove. This invention is substantially intended for solving the aforementioned problems.

A first object of the instant invention is to provide an efficient method for lubrication (impregnation, saturation, etc.) of a dental floss with medication compositions (in the forms of a liquid, gel, and the like) or/and bleaching compositions, and/or Xylitol, and/or moistening compositions, and/or suppressing appetite compositions, and/or antifungal compositions, and/or healing compositions (e.g. with vitamins), etc., simultaneously preserving the useful properties of these compositions. All these compositions are herein collectively called ‘lubricant agents’ or ‘lubricants’.

In this connection, a second object of the instant invention is to propose respective lubrication means for lubricating, impregnating, and saturating a predetermined portion of the dental floss with the lubricant agents immediately before the floss is to be used.

A third object of the instant invention is to provide a special design for the lubrication means in the form of kits that allow the user for applying the aforesaid lubricant agents through self-help actions, whereby the user medicates his/her teeth each time during the carrying out of a habitual routine of picking the teeth.

A fourth object of the instant invention is to furnish the aforesaid kits with a highly efficient type of braided (knitted) dental floss, described in the U.S. patent application Ser. No. 12/455,387 of the instant inventor, filed on 1 Jun. 2009. This generally provides an enhanced quality of cleaning and a possibility of applying the lubricant agents to hard-to-reach places between the teeth, under dental bridges, in sulcus areas, etc.

Other aims or applications of the instant invention might be found by those skilled in the art, or might become apparent from a consideration of the drawings, ensuing description, and claims as hereinafter related.

The aforesaid objects have been achieved through providing two design variants of kits for lubrication of the dental floss as follows below.

### Inventive Kit—First Design Variant

Therefore, there is provided a first kit for lubrication of a dental floss, wherein the first kit comprises: a predetermined number (starting from 1, but preferably a plurality) of floss pieces of the dental floss, wherein each such floss piece has a predetermined length convenient for flossing a human's teeth; a flat base; a panel including a plurality of longitudinal partitions configured to form a plurality of channels therebetween, so that each such channel contains one aforesaid floss piece placed into the channel as an elongated loop having a bend at a first channel end of the channel and two free ends at a second channel end of the channel, the panel is coupled with the flat base; a predetermined number of lubrication zones each transversely spanning through a predetermined number of the first channel ends (forming a group of the first channel ends, wherein each such group may consist of one or more such first channel ends, up to the total number of channels, i.e. there can be formed a predetermined number of groups of the channels, equal to the predetermined number of lubrication zones in the kit), each such lubrication zone is separated from another such lubrication zone adjacent thereto (by an inter-zone partition); and a number of lubrication compartments, wherein such number of lubrication compartments corresponds to the number of lubrication zones, each such compartment faces and is associated with the respective aforesaid lubrication zone, and each such compartment contains a lubricant agent (according to the definition herein above), wherein each such lubrication compartment is formed of a flexible membrane and a respective portion of the panel, wherein each such flexible membrane is peripherally coupled to the corresponding portion of the panel, wherein each such compartment has a number of dispensing orifices corresponding to the number of the first channel ends in the respective lubrication zone, each such dispensing orifice has a predetermined size and is located in the vicinity of the bend of the respective floss piece predeterminedly distant from the bend, such that the vicinities of the bends of the floss pieces disposed in the respective lubrication zone can be lubricated by the lubricant agent upon a user's depressing on the flexible membrane of this lubrication zone.

Thereafter, the user ejects the freshly lubricated floss piece by pulling it out of the channel, and utilizes one floss piece for flossing the teeth; or, if necessary, utilizes more pieces, up to the number of floss pieces lubricated in the respective lubrication zone. Since the lubricated floss is deployed immediately prior to the flossing, it cannot decompose or lose its healing properties. Also, due to the design of the first kit, only the middle section of the floss piece is lubricated, which saves the lubricant agent, and makes the kit less expensive. The kit is convenient to use in regular circumstances, as well as in non-stationary conditions, such as travel, etc.

During the manufacturing stage, floss pieces of the predetermined length can be cut, bent in elongated loops, and inserted into the panel's channels, as described above. Then the panel is coupled to the flat base and to the flexible membranes by any suitable means.

In the first kit, the panel and the flat base may be exemplarily composed of an appropriate type of plastic; the flexible membranes can be made of suitable materials (preferably of low-density polyethylene—LDPE). The panel, flat base, and flexible membrane can be coupled, for example, by welding, gluing, any known thermo-processing technology, etc. The first design kit may preferably comprise a protective cover that covers the second ends of the floss pieces to preserve the interior of the channels from getting dust and infection therein. Such protective cover can be placed over the corresponding edges of the flat base and the panel, and removed immediately before the use of the floss pieces.

### Inventive Kit—Second Design Variant

There is also provided a second kit for lubrication of a dental floss, wherein the kit comprises: a predetermined number (starting from 1, but preferably a plurality) of floss pieces of the dental floss, wherein each such floss piece has a predetermined length convenient for flossing a human's teeth; a panel including a predetermined number (can be 1, but preferably a plurality) of cells, each such cell includes a dry cavity and a lubricant cavity disposed adjacently to the dry cavity, wherein each aforesaid floss piece is formed as an elongated loop having a bend located in the middle portion of the floss piece, and two free ends, wherein each aforesaid floss piece is placed into the corresponding aforesaid cell, such that the middle portion of the floss piece is placed into the lubricant cavity of the cell, and the free ends are placed into the dry cavity of the cell; and a flat cover coupled to the panel such that the flat cover sealingly covers the cells of aforesaid panel.

The flat cover is preferably made of suitable foil that can be easily removed from one or more such cells by tearing off a necessary portion of the flat cover. The panel can be made of a suitable material, e.g. an appropriate type of plastic. It is preferable that a user should be able to cut the panel and the flat cover into units of a necessary size, e.g. consisting of one or more aforesaid cells. The panel and the flat cover can be coupled, for example, by gluing or thermo-processing.

For using the floss pieces, the user removes the respective portion of aforesaid flat cover from a corresponding aforesaid cell, and pulls the floss piece out. He/she holds the dry free ends with the fingers, and flosses the teeth with the middle portion of the freshly lubricated floss piece.

### Preferable Type of Floss for the Inventive Kits

It is preferable to employ ‘Magic Floss’ as the dental floss for the inventive kits. The Magic Floss was disclosed in the U.S. patent application Ser. No. 12/455,387, herein entirely incorporated by reference, by the instant inventor as follows: “the knit floss consists of strands braided with each other in a multi-stitch (or multi-looped) manner so that collectively form a volumetric knit structure having a longitudinal axis. If the floss is horizontally disposed, a projection of the structure on any axial plane, extended through the longitudinal axis, represents a planar pattern having an upper contour and a lower contour with a periodically changing width therebetween, i.e. having ‘concave’ and ‘convex’ portions. Therefore, the knit structure consists of a plurality of multi-stitch sections twisted in relation to each other along the longitudinal direction at predetermined angles (that provides a permanently changeable spatial orientation of the sections) . . . .”

### BRIEF DESCRIPTION OF DRAWINGS

FIG. 1 illustrates a frontal, plan, and lateral sectional views of the first design variant inventive kit.

FIGS. 1a, 1b, and 1c schematically illustrate enlarged fragments of the first design variant inventive kit depicted on FIG. 1.

FIG. 2 illustrates frontal and lateral sectional views of one cell of the second design variant inventive kit.

FIG. 2a illustrates frontal and lateral sectional views of the second design variant inventive kit with a plurality of cells.

Identical reference numerals or letters in the drawings generally refer to the same elements in different figures. A first-time introduced numeral or letter in the description is enclosed into parentheses.

### DETAIL DESCRIPTION OF PREFERRED EMBODIMENTS OF THE INVENTION

While the invention may be susceptible to embodiment in different forms, there will be described in detail herein, specific embodiments of the instant invention, with the understanding that the present disclosure is to be considered an exemplification of the principles of the invention, and is not intended to limit the invention to that as illustrated and described herein.

### Inventive Kit—First Design Variant

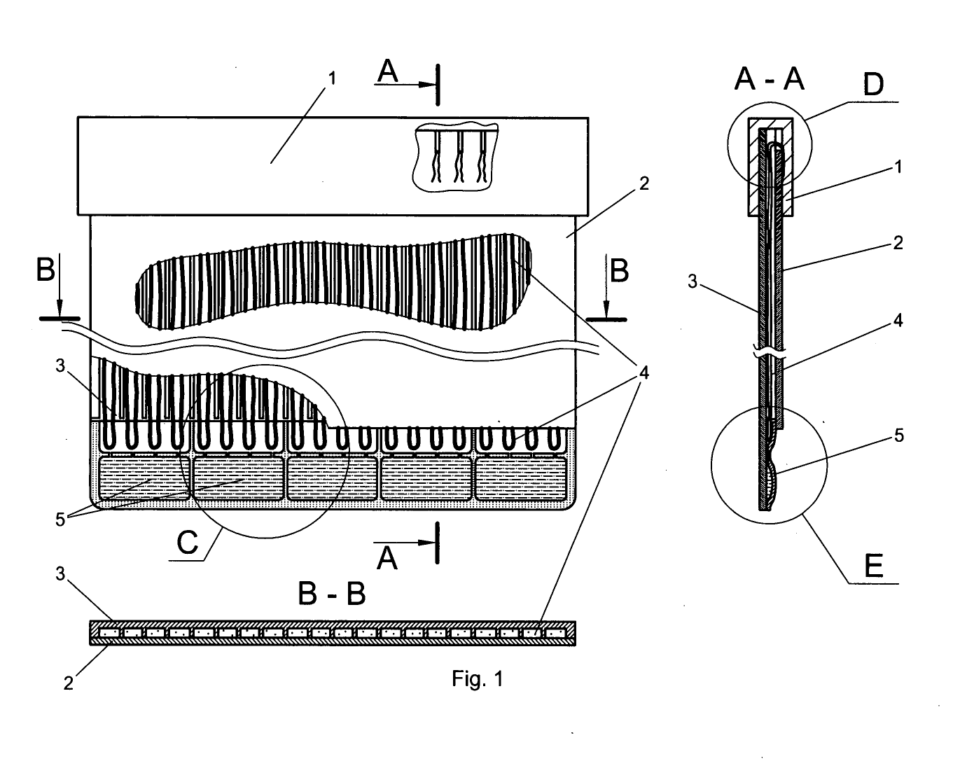

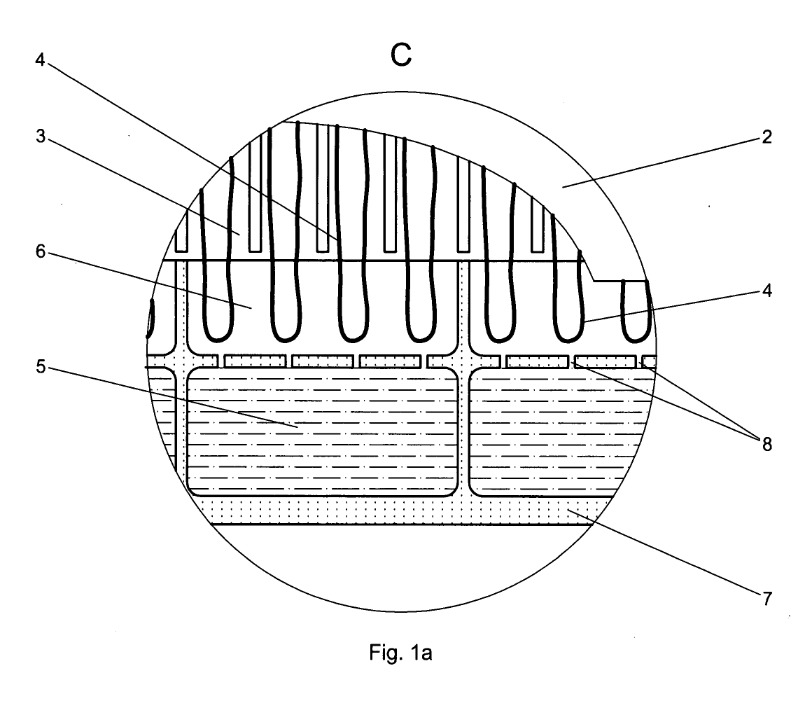

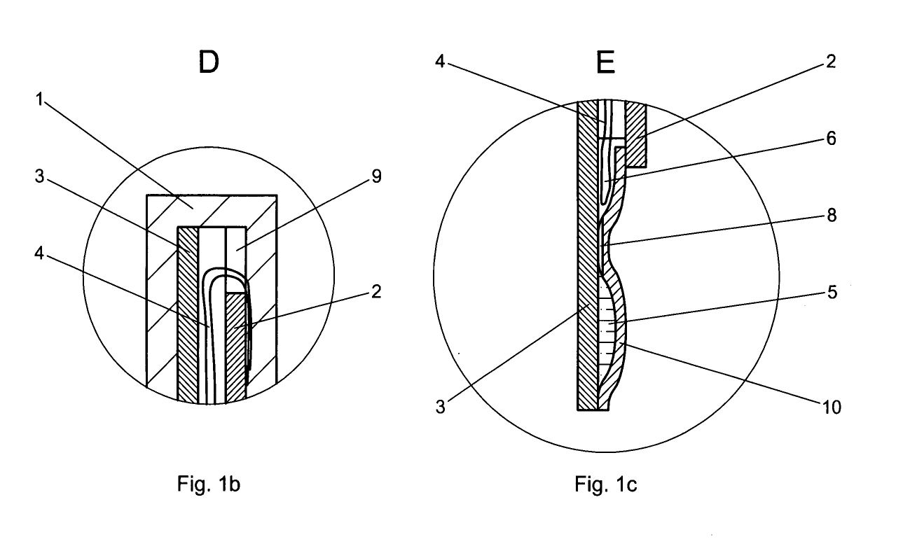

Referring to FIGS. 1, 1a, 1b, and 1c, there is shown the first design kit that comprises: twenty floss pieces of dental floss (4), a flat base (2); a panel (3) including a plurality of longitudinal partitions configured to form a plurality of channels therebetween, so that each such channel contains one floss piece 4 placed into the channel as an elongated loop having a bend at a first channel end of the channel and two free ends at a second channel end of the channel, the panel 3 is coupled with the flat base 2; five lubrication zones (6) (depicted on FIG. 1a) each transversely spanning through four first channel ends (forming five groups of the first channel ends, wherein each such group consists of four first channel ends, making the total number of channels equal to 20 in the kit), each lubrication zone 6 is separated from another such lubrication zone 6 adjacent thereto (by an inter-zone partition); a number of lubrication compartments (5), corresponding to the number of lubrication zones 6.

Each compartment 5 faces and is associated with the respective lubrication zone 6, and each compartment 5 contains a lubricant agent (according to the definition herein above), wherein each lubrication compartment 5 is formed of a flexible membrane (10) (depicted on FIG. 1c) and a rear wall (7) (depicted on FIG. 1a) of the panel 3, wherein each such flexible membrane is peripherally coupled to the corresponding portion of the panel 3. Each compartment 5 has a number of dispensing orifices (8) (depicted on FIG. 1a) corresponding to the number of the first channel ends in the respective lubrication zone 6, each dispensing orifice 8 has a predetermined size and is located in the vicinity of the bend of the respective floss piece 4 predeterminedly distant from the bend, such that the bends of the floss pieces 4, disposed in the respective lubrication zone 6, can be lubricated by the lubricant agent upon a user's depressing on the flexible membrane 10 of this lubrication zone 6.

On the side of the second channel ends, the flat base 2 is formed shorter than the panel 3, thereby forming an exit space (9) (depicted on FIG. 1b). The first design kit comprises a protective cover (1) that covers the exit space 9 to preserve the interior of the channels from getting dust and infection therein. The user removes the cover 1, ejects the freshly lubricated floss piece 4 by pulling it out from the exit space 9, and utilizes a floss piece 4 for flossing the teeth.

### Inventive Kit—Second Design Variant

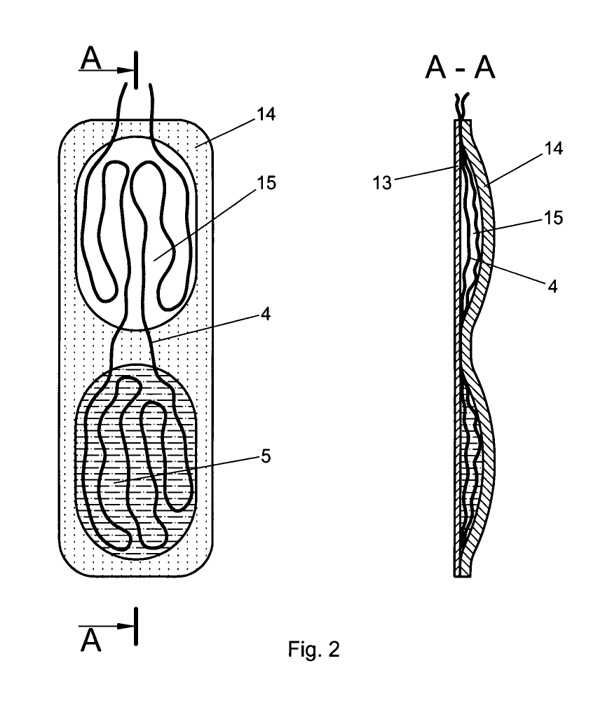

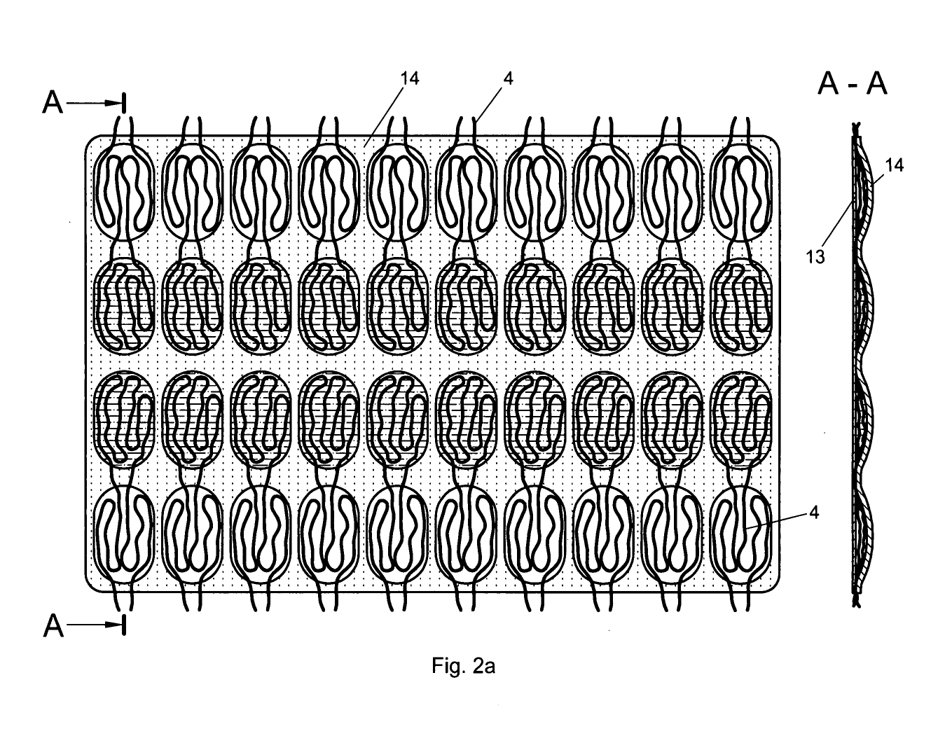

Referring to FIG. 2, there is shown the second design kit for lubrication of a dental floss, which kit comprises: a floss piece 4 of the dental floss; a panel 14 consisting of one cell, the cell in turn includes a dry cavity (15) (that has no lubricant) and a lubricant cavity 5 (or a compartment containing a lubricant agent similar to the compartment 5 of the first design kit above) disposed adjacently to the dry cavity 15, wherein the floss piece 4 is formed as an elongated loop having a bend located in the middle portion of the floss piece, and two free ends, wherein the floss piece is placed into the cell, such that the middle portion of the floss piece 4 is placed into the lubricant cavity 5, and the free ends are placed into the dry cavity 15. The second design kit also comprises a flat cover (13) coupled to the panel 14, such that the flat cover 13 sealingly covers the cell of the panel 14.

Referring to FIG. 2a, there is shown the second design kit for lubrication of a dental floss, which kit comprises: twenty floss piece 4 of the dental floss; a panel 14 consisting of twenty cells, wherein each such cell is constructed as described above for FIG. 2. The second design kit comprises a flat cover 13 coupled to the panel 14, such that the flat cover 13 sealingly covers the entire panel 14.

The user removes the respective portion of the flat cover 13 from a corresponding cell, and pulls the floss piece 4 out. He/she holds the dry free ends of the floss piece 4 with the fingers, and flosses the teeth with the middle portion of the freshly lubricated floss piece 4.

As mentioned above, the lubricant agent may include at least one of the following: fluoride, a bleaching composition, Xylitol, a moistening composition, a suppressing appetite composition, a healing composition, and an antifungal composition, etc.

I claim:

1. A kit for lubrication of a dental floss, wherein said kit comprises:
a predetermined number of floss pieces of the dental floss;
a flat base;
a panel including a plurality of longitudinal partitions configured to form a plurality of channels therebetween, so that each said channel contains one said floss piece placed into the channel as an elongated loop having a bend at a first channel end of the channel and two free ends at a second channel end of the channel, the panel is coupled with the flat base;
a predetermined number of lubrication zones each transversely spanning through a predetermined number of the first channel ends, each said lubrication zone is separated from another said lubrication zone adjacent thereto; and
a number of lubrication compartments, corresponding to the number of said lubrication zones, each said compartment faces and is associated with the respective said lubrication zone, and each said compartment contains a lubricant agent, wherein each said lubrication compartment is formed of a flexible membrane and a respective portion of said panel, wherein each said flexible membrane is peripherally coupled to said panel, wherein each said compartment has a number of dispensing orifices corresponding to the number of said first channel ends in the respective lubrication zone, wherein each said dispensing orifice has a predetermined size and is located in the vicinity of the bend of the respective floss piece predeterminedly distant from the bend, such that the vicinities of said bends of said floss pieces disposed in the respective lubrication zone can be lubricated by the lubricant agent upon a user's depressing on said flexible membrane of this lubrication zone.

2. The kit according to claim 1, wherein said panel is made of plastic, and said membrane is made of low-density polyethylene.

3. The kit according to claim 1, wherein the panel, the flat base, and the flexible membranes are coupled by welding, or gluing, or thermo-processing.

4. The kit according to claim 1, further comprising a protective cover that removably covers said second ends of the floss pieces.

5. The kit according to claim 1, wherein said dental floss consists of
a plurality of multi-stitch sections twisted in relation to each other along a longitudinal direction at predetermined angles providing a permanently changeable spatial orientation of the sections; said sections each consists of
a plurality of strands braided with each other in a multi-stitch manner so that said sections collectively form a volumetric knit structure having a longitudinal axis; said structure, being horizontally disposed, forms a projection on any axial plane, extended through the longitudinal axis, wherein said projection represents a planar pattern having an upper contour and a lower contour with a periodically changing width therebetween, thereby forming concave and convex portions in said planar pattern.

6. The kit according to claim 1, wherein said lubricant agent includes at least one of the following: fluoride, a bleaching composition, Xylitol, a moistening composition, a suppressing appetite composition, a healing composition, and an antifungal composition.

7. A kit for lubrication of a dental floss, wherein said kit comprises:
a predetermined number of floss pieces of the dental floss;
a panel including a predetermined number of cells, each said cell includes a dry cavity and a lubricant cavity disposed adjacently to the dry cavity, wherein each said floss piece is formed as an elongated loop having a bend located in the middle portion of the floss piece, and two free ends, wherein each said floss piece is placed into the corresponding said cell, such that the middle portion of the floss piece is placed into the lubricant cavity, and the free ends are placed into the dry cavity; and
a flat cover coupled to the panel such that said flat cover sealingly covers the cells of said panel.

8. The kit according to claim 7, wherein said panel is made of plastic, and said flat cover is made of foil.

9. The kit according to claim 7, wherein said panel and said flat cover are coupled by gluing or thermo-processing.

10. The kit according to claim 7, wherein said dental floss consists of
a plurality of multi-stitch sections twisted in relation to each other along a longitudinal direction at predetermined angles providing a permanently changeable spatial orientation of the sections; said sections each consists of
a plurality of strands braided with each other in a multi-stitch manner so that said sections collectively form a volumetric knit structure having a longitudinal axis; said structure, being horizontally disposed, forms a projection on any axial plane, extended through the longitudinal axis, wherein said projection represents a planar pattern having an upper contour and a lower contour with a periodically changing width therebetween, thereby forming concave and convex portions in said planar pattern.

11. The kit according to claim 7, wherein said lubricant agent includes at least one of the following: fluoride, a bleaching composition, Xylitol, a moistening composition, a suppressing appetite composition, a healing composition, and an antifungal composition.
